(19) United States
(12) Patent Application Publication
(10) Pub. No.: US 2026/0205324 A1
(43) Pub. Date: Jul. 16, 2026

(54) System and Method for Seamless Virtual Local Area Network (VLAN) Identifier Reconfiguration

(71) Applicant: Dell Products L.P., Round Rock, TX (US)

(72) Inventors: Ishay Zekri, Kfar Yona (IL); Marina Shem Tov, Hod HaSharon (IL); Vasiliy Tolstoy, Dublin (IE)

(21) Appl. No.: 19/020,654

(22) Filed: Jan. 14, 2025

(51) Int. Cl. H04L 12/46; H04L 41/0803

(52) U.S. Cl. CPC H04L 12/4645; H04L 41/0803

(57) ABSTRACT

A method, computer program product, and computing system for processing network packets to and from a multi-node storage system within a Virtual Local Area Network (VLAN) using an original VLAN device with a VLAN device identifier. A new VLAN device is generated with a new VLAN device identifier within the VLAN. Incoming packets with the new VLAN device identifier are filtered on the new VLAN device. Outgoing packets with an original VLAN device identifier are tagged on the new VLAN device. The original VLAN device on each node is modified to tag outgoing packets on the original VLAN device with the new VLAN device identifier. In response to modifying the original VLAN device to tag outgoing packets on the original VLAN with the new VLAN device identifier on each node of the multi-node storage system, outgoing packets are tagged on the new VLAN device with the new VLAN device identifier.

### BACKGROUND

Storing and safeguarding electronic content may be beneficial in modern business and elsewhere. Accordingly, various methodologies may be employed to protect and distribute such electronic content.

For example, in the computer networking space, a virtual local area network (VLAN) provides network segmentation, simpler network management, improved network security, among other features. A VLAN behaves like a virtual switch or network link that can share the same physical structure with other VLANs while staying logically separate. Between network devices, VLANs work by applying tags to network frames and handling these tags in networking systems. VLANs allow network administrators to group hosts together and allow devices that must be kept separate to share the cabling of a physical network and yet be prevented from directly interacting with one another. Advanced storage solutions use VLAN identifiers to access the storage network from an external host, and in some cases, VLAN identifier filtering is used for internal communication between different servers of a storage cluster. When a VLAN is configured with a VLAN ID for storage or internal storage management, reconfiguration of the VLAN can result in issues among existing VLAN devices.

### SUMMARY OF DISCLOSURE

In one example implementation, a computer-implemented method executed on a computing device may include, but is not limited to, processing network packets to and from a multi-node storage system within a Virtual Local Area Network (VLAN) using an original VLAN device with a VLAN device identifier. A new VLAN device is generated with a new VLAN device identifier within the VLAN. Incoming network packets with the new VLAN device identifier are filtered on the new VLAN device. Outgoing network packets with an original VLAN device identifier are tagged on the new VLAN device. The original VLAN device on each node of the multi-node storage system is modified to tag outgoing network packets on the original VLAN device with the new VLAN device identifier. In response to modifying the original VLAN device to tag outgoing network packets on the original VLAN with the new VLAN device identifier on each node of the multi-node storage system, outgoing network packets are tagged on the new VLAN device with the new VLAN device identifier.

One or more of the following example features may be included. The VLAN device couples the multi-node storage system with one or more external host devices. The multi-node storage system may include a pair of nodes in an active-active storage configuration. Generating the new VLAN device may include generating the new VLAN device on each node of the pair of nodes. In response to filtering the incoming network packets on the new VLAN device with the new VLAN device identifier, the incoming network packets may be untagged on the new VLAN device. Incoming network packets may be filtered on the original VLAN device with the original VLAN device identifier. In response to tagging outgoing network packets on the new VLAN device with the new VLAN device identifier, the original VLAN device may be removed from the VLAN.

In another example implementation, a computer program product resides on a computer readable medium that has a plurality of instructions stored on it. When executed by a processor, the instructions cause the processor to perform operations that may include, but are not limited to, processing network packets to and from a multi-node storage system within a Virtual Local Area Network (VLAN) using an original VLAN device with a VLAN device identifier. A new VLAN device is generated with a new VLAN device identifier within the VLAN. Incoming network packets with the new VLAN device identifier are filtered on the new VLAN device. Outgoing network packets with an original VLAN device identifier are tagged on the new VLAN device. The original VLAN device on each node of the multi-node storage system is modified to tag outgoing network packets on the original VLAN device with the new VLAN device identifier. In response to modifying the original VLAN device to tag outgoing network packets on the original VLAN with the new VLAN device identifier on each node of the multi-node storage system, outgoing network packets are tagged on the new VLAN device with the new VLAN device identifier.

One or more of the following example features may be included. The VLAN device couples the multi-node storage system with one or more external host devices. The multi-node storage system may include a pair of nodes in an active-active storage configuration. Generating the new VLAN device may include generating the new VLAN device on each node of the pair of nodes. In response to filtering the incoming network packets on the new VLAN device with the new VLAN device identifier, the incoming network packets may be untagged on the new VLAN device. Incoming network packets may be filtered on the original VLAN device with the original VLAN device identifier. In response to tagging outgoing network packets on the new VLAN device with the new VLAN device identifier, the original VLAN device may be removed from the VLAN.

In another example implementation, a computing system includes at least one processor and at least one memory architecture coupled with the at least one processor, wherein the at least one processor is configured to process network packets to and from a multi-node storage system within a Virtual Local Area Network (VLAN) using an original VLAN device with a VLAN device identifier. A new VLAN device is generated with a new VLAN device identifier within the VLAN. Incoming network packets with the new VLAN device identifier are filtered on the new VLAN device. Outgoing network packets with an original VLAN device identifier are tagged on the new VLAN device. The original VLAN device on each node of the multi-node storage system is modified to tag outgoing network packets on the original VLAN device with the new VLAN device identifier. In response to modifying the original VLAN device to tag outgoing network packets on the original VLAN with the new VLAN device identifier on each node of the multi-node storage system, outgoing network packets are tagged on the new VLAN device with the new VLAN device identifier.

One or more of the following example features may be included. The VLAN device couples the multi-node storage system with one or more external host devices. The multi-node storage system may include a pair of nodes in an active-active storage configuration. Generating the new VLAN device may include generating the new VLAN device on each node of the pair of nodes. In response to filtering the incoming network packets on the new VLAN device with the new VLAN device identifier, the incoming network packets may be untagged on the new VLAN device. Incoming network packets may be filtered on the original VLAN device with the original VLAN device identifier. In response to tagging outgoing network packets on the new VLAN device with the new VLAN device identifier, the original VLAN device may be removed from the VLAN.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a VLAN reconfiguration process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the VLAN reconfiguration process of FIG. 1 according to one or more example implementations of the disclosure; and

FIGS. 4-9 are example diagrammatic views of the VLAN reconfiguration process of FIG. 3 according to one or more example implementations of the disclosure.

Like reference symbols in the various drawings indicate like elements.

### DETAILED DESCRIPTION

### System Overview

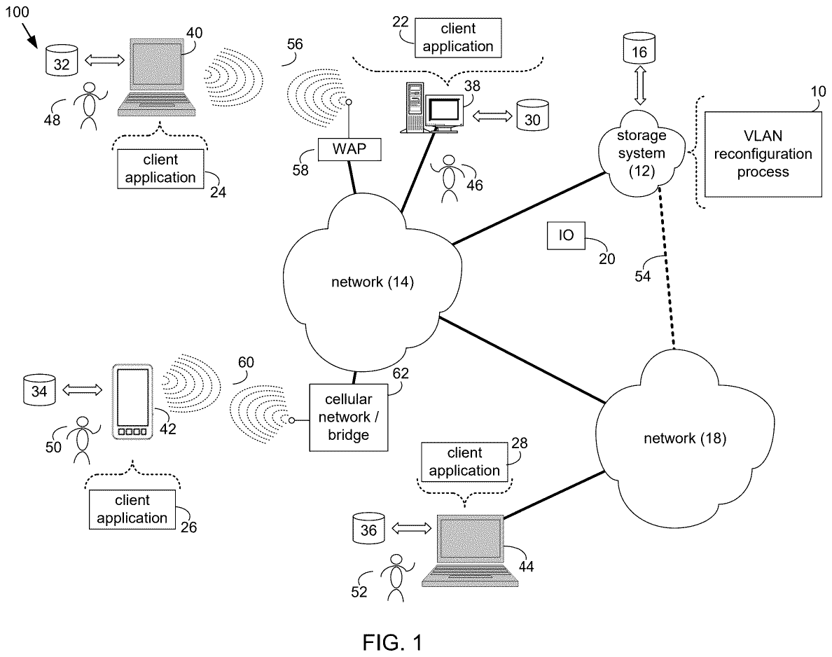

Referring to FIG. 1, there is shown VLAN reconfiguration process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of VLAN reconfiguration process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of VLAN reconfiguration process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a VLAN reconfiguration process, such as VLAN reconfiguration process 10 of FIG. 1, may include but is not limited to, processing network packets to and from a multi-node storage system within a Virtual Local Area Network (VLAN) using an original VLAN device with a VLAN device identifier. A new VLAN device is generated with a new VLAN device identifier within the VLAN. Incoming network packets with the new VLAN device identifier are filtered on the new VLAN device. Outgoing network packets with an original VLAN device identifier are tagged on the new VLAN device. The original VLAN device on each node of the multi-node storage system is modified to tag outgoing network packets on the original VLAN device with the new VLAN device identifier. In response to modifying the original VLAN device to tag outgoing network packets on the original VLAN with the new VLAN device identifier on each node of the multi-node storage system, outgoing network packets are tagged on the new VLAN device with the new VLAN device identifier.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

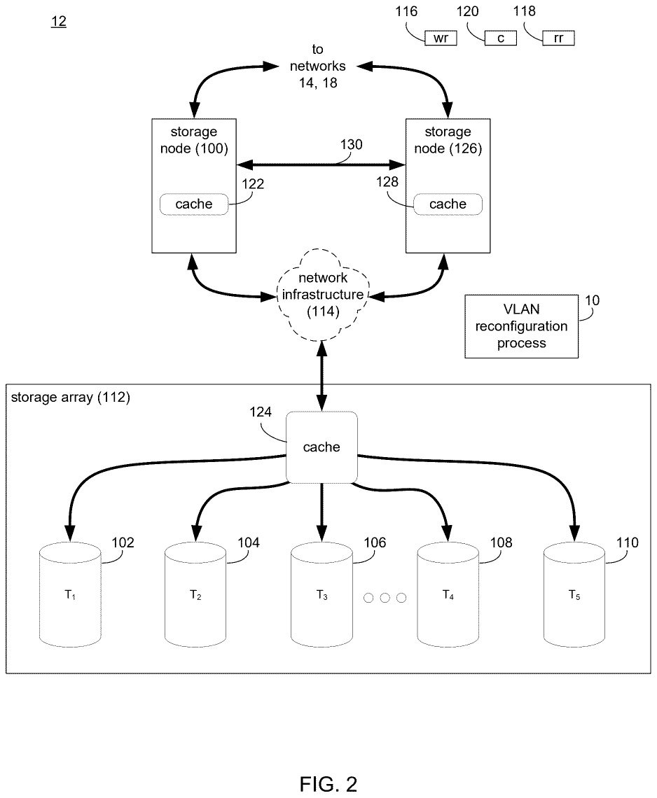

Referring also to FIG. 2, storage system 12 may include storage node 100 and a plurality of storage targets T 1−n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage node 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage node 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage node 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of VLAN reconfiguration process 10. The instruction sets and subroutines of VLAN reconfiguration process 10, which may be stored on a storage device (e.g., storage device 16) coupled to storage node 100, may be executed by one or more processors (not shown) and one or more memory architectures (not shown) included within storage node 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of VLAN reconfiguration process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage node 100 is configured as an application server, these IO requests may be internally generated within storage node 100. Examples of IO request 20 may include but are not limited to data write request 116 (e.g., a request that content 118 be written to storage system 12) and data read request 120 (i.e., a request that content 118 be read from storage system 12).

During operation of storage node 100, content 118 to be written to storage system 12 may be processed by storage node 100. Additionally/alternatively and when storage node 100 is configured as an application server, content 118 to be written to storage system 12 may be internally generated by storage node 100.

Storage node 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage node 100 may initially store content 118 within frontend cache memory system 122. Depending upon the manner in which frontend cache memory system 122 is configured, storage node 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage node 100. Data array 112 may initially store content 118 within backend cache memory system 124 prior to being stored on e.g., one or more of storage targets 102, 104, 106, 108, and coded target 110.

As discussed above, the instruction sets and subroutines of VLAN reconfiguration process 10, which may be stored on storage device 16 included within storage system 12, may be executed by one or more processors (not shown) and one or more memory architectures (not shown) included within storage system 12. Accordingly, in addition to being executed on storage node 100, some or all of the instruction sets and subroutines of VLAN reconfiguration process 10 may be executed by one or more processors (not shown) and one or more memory architectures (not shown) included within data array 112.

Further and as discussed above, during the operation of data array 112, content (e.g., content 118) to be written to data array 112 may be received from storage node 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage nodes 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage node 126 may function like storage node 100. For example, during operation of storage node 126, content 118 to be written to storage system 12 may be processed by storage node 126. Additionally/alternatively and when storage node 126 is configured as an application server, content 118 to be written to storage system 12 may be internally generated by storage node 126.

Storage node 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage node 126 may initially store content 118 within frontend cache memory system 126. Depending upon the manner in which frontend cache memory system 128 is configured, storage node 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of VLAN reconfiguration process 10, which may be stored on storage device 16 included within storage system 12, may be executed by one or more processors (not shown) and one or more memory architectures (not shown) included within storage system 12. Accordingly, in addition to being executed on storage node 126, some or all of the instruction sets and subroutines of VLAN reconfiguration process 10 may be executed by one or more processors (not shown) and one or more memory architectures (not shown) included within data array 112.

Further and as discussed above, during the operation of data array 112, content (e.g., content 118) to be written to data array 112 may be received from storage node 126 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage node 100 and storage node 126 may be configured in an active/active configuration where processing of data by one storage node may be synchronized to the other storage node. For example, data may be synchronized between each storage node via a separate link or connection (e.g., connection 130).

### The VLAN Reconfiguration Process

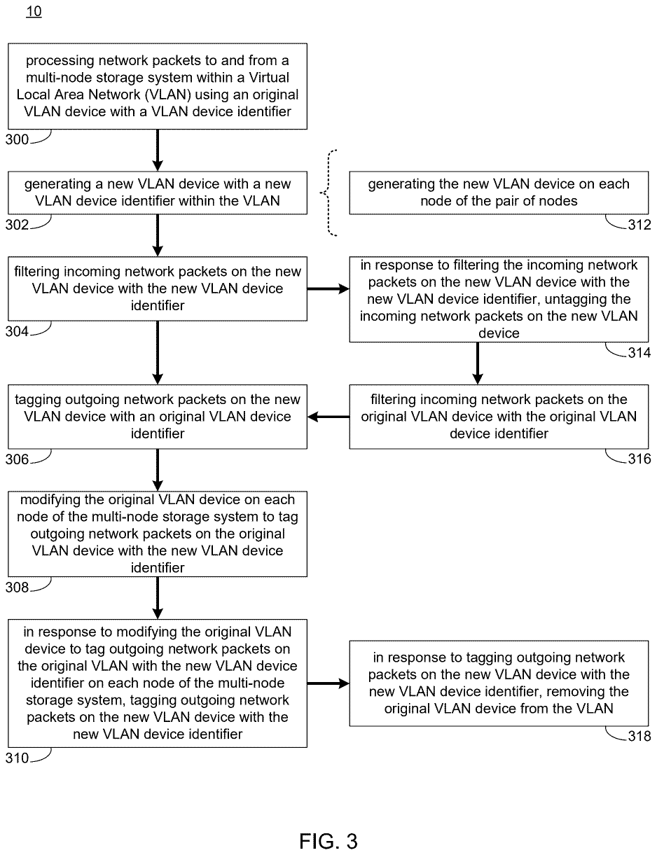

Referring also to FIGS. 3-9 and in some implementations, VLAN reconfiguration process 10 processes 300 network packets to and from a multi-node storage system within a Virtual Local Area Network (VLAN) using an original VLAN device with a VLAN device identifier. A new VLAN device is generated 302 with a new VLAN device identifier within the VLAN. Incoming network packets with the new VLAN device identifier are filtered 304 on the new VLAN device. Outgoing network packets with an original VLAN device identifier are tagged 306 on the new VLAN device. The original VLAN device on each node of the multi-node storage system is modified 308 to tag outgoing network packets on the original VLAN device with the new VLAN device identifier. In response to modifying the original VLAN device to tag outgoing network packets on the original VLAN with the new VLAN device identifier on each node of the multi-node storage system, outgoing network packets are tagged 310 on the new VLAN device with the new VLAN device identifier.

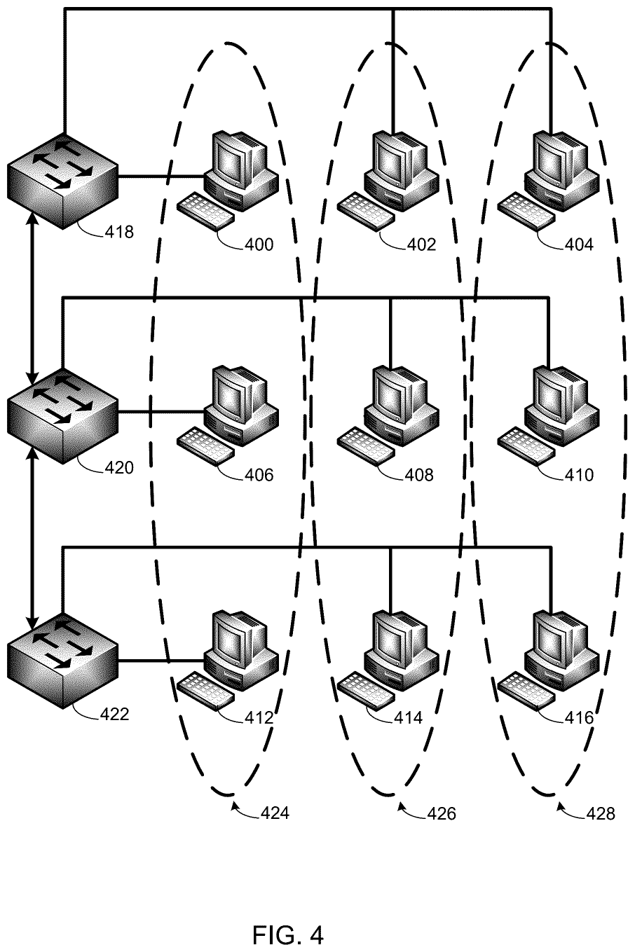

As discussed above, a Virtual Local Area Network (VLAN) is a technology that allows for the segmentation of a physical network into multiple logical networks. This segmentation is achieved by applying tags to network frames, which enables the creation of separate broadcast domains within the same physical network infrastructure. Each VLAN behaves like a separate network, even though they share the same physical hardware, allowing for improved network management and security. VLANs work by using a process called tagging, where each network packet (i.e., a segment of data that is sent over a network or digital communication link) is assigned a VLAN device identifier. The VLAN device identifier is used by network switches to determine which VLAN the packet belongs to, ensuring that traffic is only sent to devices within the same VLAN. This logical separation helps in reducing broadcast traffic and enhances security by isolating sensitive data from other parts of the network. Referring also to FIG. 4, a network of computing devices (e.g., computing devices 400, 402, 404, 406, 408, 410, 412, 414, 416) is shown with various switches (e.g., switches 418, 420, 422). Computing devices 400, 402, 404, 406, 408, 410, 412, 414, 416 with switches 418, 420, 422 form a physically connected network. However, a VLAN (e.g., VLANs 424, 426, 428) is formed by logically grouping particular computing devices and configuring network packets sent within the VLAN with a particular VLAN device identifier. A network packet transmitted by computing device 400 to computing device 414 is addressed with a VLAN device identifier specific to VLAN 424. Computing device 414 is configured to filter for the VLAN device identifier for VLAN 424 and processes these network packets while filtering out network packets with other VLAN device identifiers (e.g., VLAN device identifiers for VLANs 426, 428).

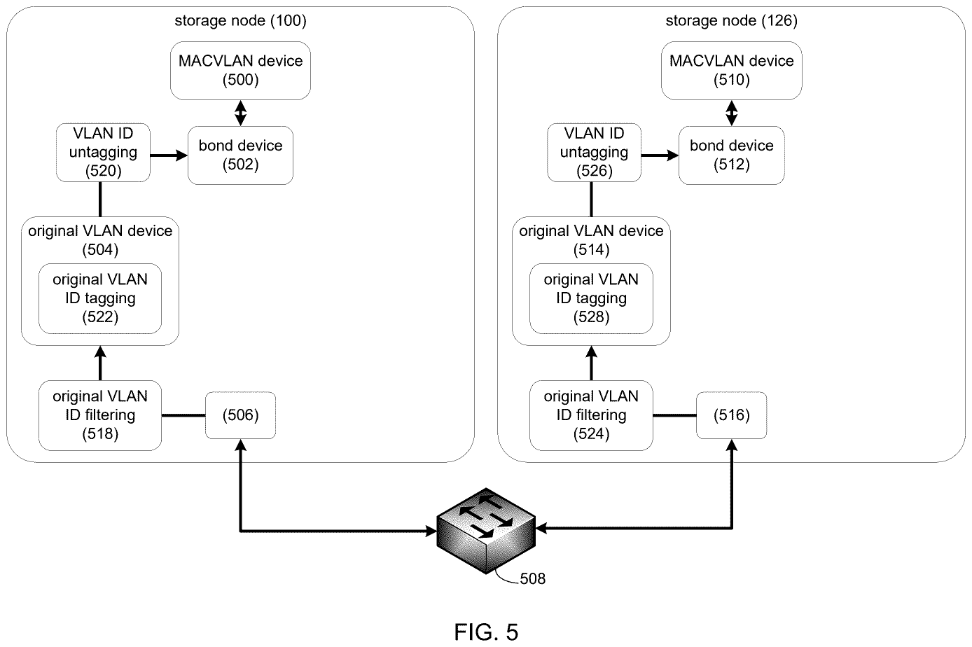

In some implementations, the VLAN device couples the multi-node storage system with one or more external host devices. Referring also to FIG. 5, a multi-node storage system (e.g., storage system 12) may include various storage nodes (e.g., storage nodes 100, 126) that process network packets and IO requests for the storage system. In some implementations, a VLAN is formed by logically coupling storage nodes 100, 126 with other computing devices (e.g., other storage systems and/or external host devices). An external host device (e.g., client electronic device 38) is a computing device that provides network packets for processing data within storage system 12.

In some implementations, VLAN reconfiguration process 10 processes 300 network packets to and from a multi-node storage system within a Virtual Local Area Network (VLAN) using an original VLAN device with a VLAN device identifier. Referring again to FIG. 5, storage node 100 includes various devices for processing network packets for the VLAN. In some implementations, storage node 100 includes MACVLAN device 500 (i.e., a network driver that allows for the creation of multiple virtual network interfaces on a single physical network interface by assigning different MAC addresses to each virtual interface, enabling them to appear as separate devices on the network); bond device 502 (i.e., an intermediary network driver that allow VLAN reconfiguration process 10 to change a VLAN device identifier without changing MACVLAN device 500); an original VLAN device (e.g., original VLAN device 504) that is a network interface that is configured to operate within a VLAN by tagging each network packet with an assigned VLAN device identifier to ensure it is only sent to devices within the same VLAN; and network connection 506 that connects storage node 100 to external network hardware (e.g., switch 508).

In some implementations, network packets received from switch 508 are “incoming network packets” and network packets being transmitted from storage node 100 are “outgoing network packets”. When incoming network packets are processed from network connection 506, original VLAN device 504 filters network packets that include a predefined original VLAN device identifier for original VLAN device 504 for processing while other network packets are rejected or dropped. This filtering is represented in FIG. 5 by original VLAN ID filtering 518. Following processing by original VLAN device 504, VLAN reconfiguration process 10 untags the incoming network packet by removing the VLAN device identifier. This untagging is represented in FIG. 5 by VLAN ID untagging 520. When processing outgoing network packets, VLAN reconfiguration process 10 tags the network packets with the original VLAN device identifier so that the destination device within the VLAN can process the network packet. This tagging is represented in FIG. 5 by original VLAN identifier tagging 522.

In some implementations, the multi-node storage system includes a pair of nodes in an active-active storage configuration. Referring again to FIG. 5 and in some implementations, storage nodes 100 and 126 form an “active-active” storage configuration where each node actively executes the same kind of service(s) simultaneously. One purpose of an active-active storage configuration may be to achieve load balancing. Load balancing may distribute workloads across all nodes in order to prevent any single node from getting overloaded. Because there are more nodes available to serve, there will also be a marked improvement in throughput and response times. Another purpose of an active-active storage configuration may be to provide at least one active node in the event that one of the nodes in the active-active cluster fails. As shown in FIG. 5, storage node 126 includes a corresponding MACVLAN device (e.g., MACVLAN device 510); bond device 512; original VLAN device 514; and network connection 516. Similarly, storage node 126 includes filtering incoming network packets for the original VLAN device identifier (e.g., original VLAN ID filtering 524); untagging of incoming network packets (e.g., VLAN ID untagging 526); and tagging outgoing network packets with the original VLAN device identifier (e.g., original VLAN ID tagging 528). As will be discussed in greater detail below, VLAN reconfiguration process 10 provides identical and simultaneous VLAN reconfiguration across all storage nodes of the multi-node storage system (e.g., storage nodes 100, 126).

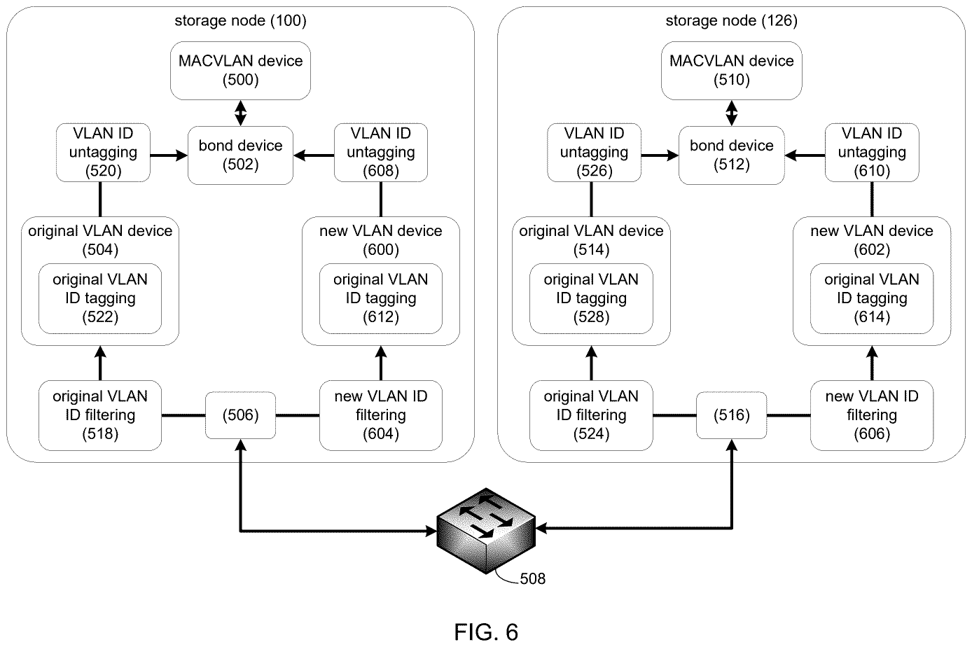

In some implementations, VLAN reconfiguration process 10 generates 302 a new VLAN device with a new VLAN device identifier within the VLAN. For example, conventional approaches to modifying or reconfiguring a VLAN device identifier cannot guarantee that the reconfiguration operation will complete across all storage nodes for a timeout and may result in issues where the failure to create or remove a VLAN device in one storage node causes disconnection of the VLAN. Accordingly, implementations of the present disclosure provide an enhanced VLAN device which enables VLAN ID reconfiguration in a sequential manner on different storage nodes without losing connectivity at any point in time. Accordingly, VLAN reconfiguration process 10 provides an improved or “enhanced” VLAN device that allows for the tagging of outgoing network packets with one VLAN ID, which can be different from the filtered VLAN ID for incoming network packets. In some implementations, a new VLAN device is a network interface that is configured to operate within a VLAN by tagging each network packet with the new VLAN device identifier. Referring also to FIG. 6, a new VLAN device (e.g., new VLAN device 600) is generated 302 for storage node 100 by VLAN reconfiguration process 10 with a new VLAN device identifier that is different than the original VLAN device identifier for original VLAN device 504. In some implementations, generating 302 the new VLAN device includes generating 312 the new VLAN device on each node of the pair of nodes. As shown in FIG. 6, VLAN reconfiguration process 10 generates a corresponding new VLAN device (e.g., new VLAN device 602) for storage node 126.

In some implementations, VLAN reconfiguration process 10 filters 304 incoming network packets on the new VLAN device with the new VLAN device identifier. For example, during reconfiguration, VLAN reconfiguration process 10 processes incoming network packets with the new VLAN device identifier by filtering 304 incoming network packets on the new VLAN device with the new VLAN device identifier. This is represented in FIG. 6 as new VLAN ID filtering 604 for new VLAN device 600 on storage node 100 and as new VLAN ID filtering 606 for new VLAN device 602 on storage node 126.

In some implementations and in response to filtering 304 the incoming network packets on the new VLAN device with the new VLAN device identifier, VLAN reconfiguration process 10 untags 314 the incoming network packets on the new VLAN device. For example, using new VLAN device 600 on storage node 100 and new VLAN device 602 on storage node 126, VLAN reconfiguration process 10 processes incoming network packets on the respective storage node by untagging 314 the incoming network packets with the new VLAN device identifier. Untagging 314 an incoming network packet with the new VLAN device identifier includes removing the new VLAN device identifier from the incoming network packet. This is represented in FIG. 6 as VLAN ID untagging 608 for new VLAN device 600 and as VLAN ID tagging 610 for new VLAN device 602.

In some implementations, VLAN reconfiguration process 10 filters 316 incoming network packets on the original VLAN device with the original VLAN device identifier. For example and in contrast to new VLAN device, original VLAN device 504 continues to filter 316 incoming network packets with the original VLAN device identifier. In this manner, original VLAN device 504 and original VLAN device 514 are able to continue filtering for and processing incoming network packets with the original VLAN device identifier.

In some implementations, VLAN reconfiguration process 10 tags 306 outgoing network packets on the new VLAN device with an original VLAN device identifier. For example, when initially generated, VLAN reconfiguration process 10 configures new VLAN device to tag 306 outgoing network packets with an original VLAN device identifier. The tagging of outgoing network packets with the original VLAN device identifier ensures that outgoing network packets are successfully processed by a destination computing device on the original VLAN device. In this manner, VLAN reconfiguration process 10 is able to simultaneously process network packets with the original VLAN device identifier and the new VLAN device identifier without removing either VLAN device at this point in the reconfiguration. This is represented in FIG. 6 as original VLAN ID tagging 612 for new VLAN device 600 and original VLAN ID tagging 614 for new VLAN device 602.

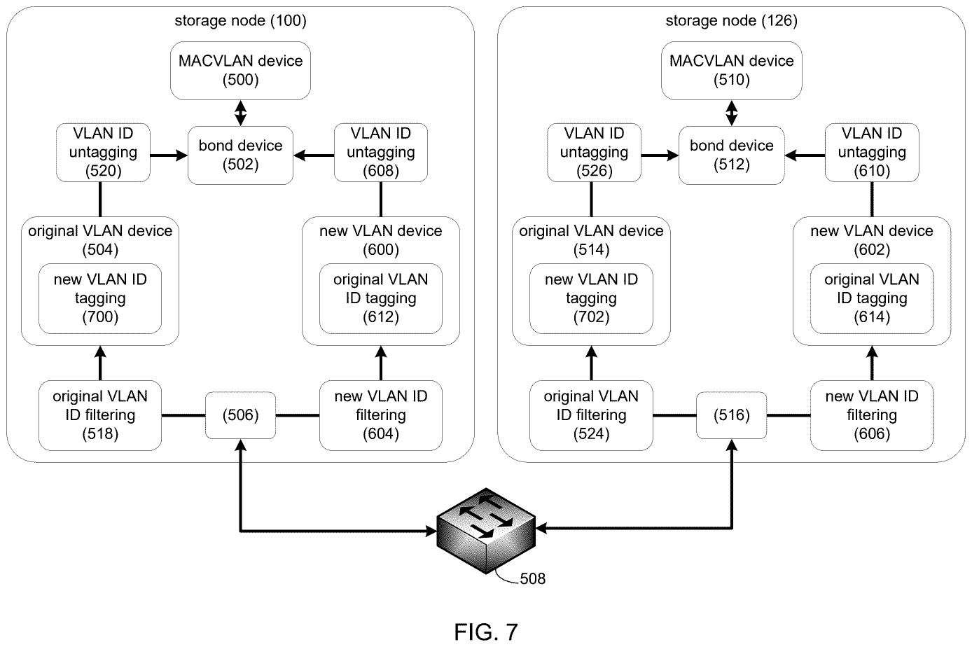

In some implementations, VLAN reconfiguration process 10 modifies 308 the original VLAN device on each node of the multi-node storage system to tag outgoing network packets on the original VLAN device with the new VLAN device identifier. For example, with new VLAN devices on each storage node tagging outgoing network packets with the original VLAN device identifier, VLAN reconfiguration process 10 modifies 308 original VLAN devices 504, 514 to tag outgoing network packets with the new VLAN device identifier associated with new VLAN devices 600, 602. Referring also to FIG. 7, this is represented as new VLAN ID tagging 700 for original VLAN device 504 and new VLAN ID tagging 702 for original VLAN ID device 514.

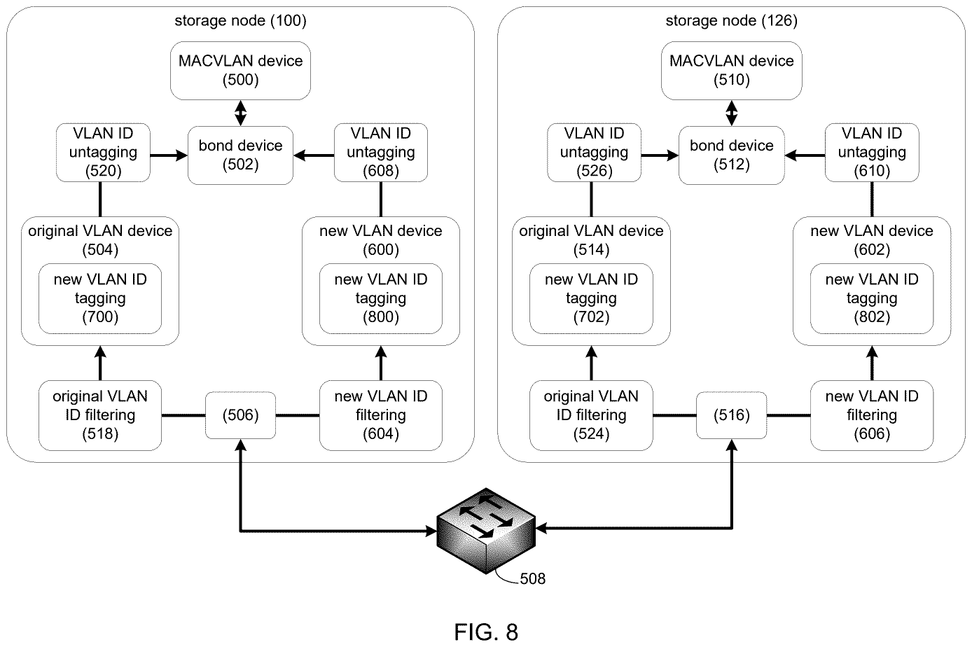

In some implementations and in response to modifying the original VLAN device to tag outgoing network packets on the original VLAN with the new VLAN device identifier on each node of the multi-node storage system, VLAN reconfiguration process 10 tags 310 outgoing network packets on the new VLAN device with the new VLAN device identifier. For example, with each original VLAN device on each storage node modified to tag outgoing network packets with the new VLAN device identifier, VLAN reconfiguration process 10 modifies outgoing network packets on new VLAN devices 600, 602 with the new VLAN device identifier. With this configuration, original VLAN devices 504, 514 continue to filter for incoming network packets with the original VLAN identifier while both VLAN devices tag outgoing network packets with the new VLAN identifier. Referring also to FIG. 8, this is represented as new VLAN ID tagging 800 for new VLAN device 600 and new VLAN ID tagging 802 for new VLAN ID device 602.

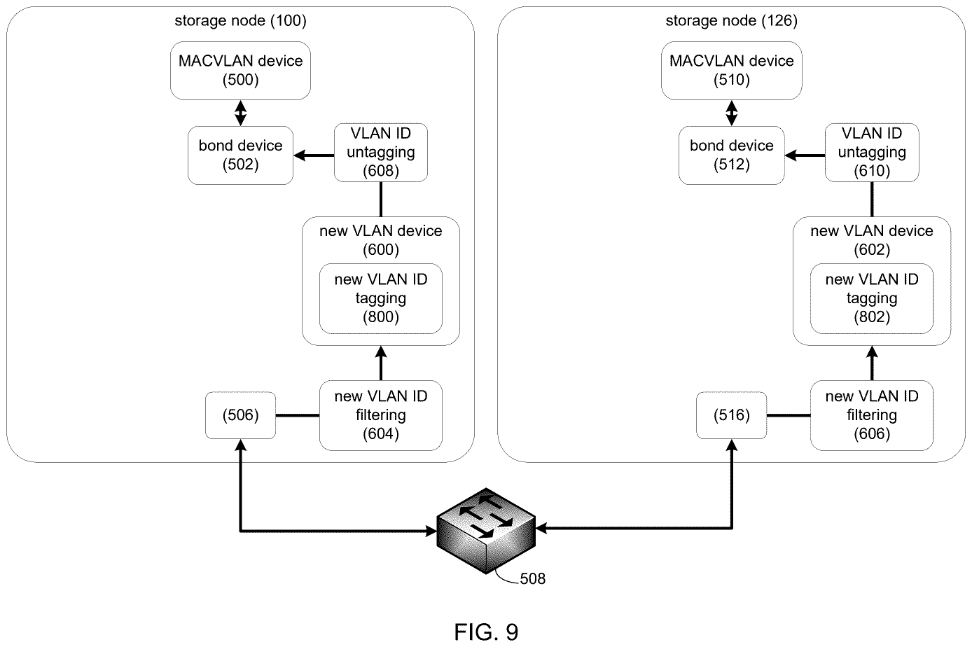

In some implementations and in response to tagging outgoing network packets on the new VLAN device with the new VLAN device identifier, VLAN reconfiguration process 10 removes 318 the original VLAN device from the VLAN. For example, following the modification of both original VLAN devices and new VLAN devices to tag outgoing network packets using the new VLAN device identifier, the original VLAN device that filters for incoming network packets using the original VLAN device identifier will become obsolete. In some implementations, VLAN reconfiguration process 10 removes 318 the original VLAN device from the VLAN. In one example, VLAN reconfiguration process 10 determines whether any incoming network packets include the original VLAN device identifier before removing 318 the original VLAN device. In another example, VLAN reconfiguration process 10 defines a limited amount of time and/or incoming network packets before removing 318 the original VLAN devices. Accordingly, it will be appreciated that the conditions for removing 318 the original VLAN device from the VLAN vary within the scope of the present disclosure. Referring also to FIG. 9, VLAN reconfiguration process 10 removes 318 original VLAN devices 504, 514 and processes incoming network packets and outgoing network packets using new VLAN devices 600, 602 that tag and filter network packets using the new VLAN device identifier. With the removal of original VLAN devices 504, 514, VLAN reconfiguration process 10 completes the reconfiguration of the VLAN.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
processing network packets to and from a multi-node storage system within a Virtual Local Area Network (VLAN) using an original VLAN device with a VLAN device identifier;
generating a new VLAN device with a new VLAN device identifier within the VLAN;
filtering incoming network packets on the new VLAN device with the new VLAN device identifier;
tagging outgoing network packets on the new VLAN device with an original VLAN device identifier;
modifying the original VLAN device on each node of the multi-node storage system to tag outgoing network packets on the original VLAN device with the new VLAN device identifier; and
in response to modifying the original VLAN device to tag outgoing network packets on the original VLAN with the new VLAN device identifier on each node of the multi-node storage system, tagging outgoing network packets on the new VLAN device with the new VLAN device identifier.

2. The computer-implemented method of claim 1, wherein the VLAN device couples the multi-node storage system with one or more external host devices.

3. The computer-implemented method of claim 1, wherein the multi-node storage system includes a pair of nodes in an active-active storage configuration.

4. The computer-implemented method of claim 3, wherein generating the new VLAN device includes generating the new VLAN device on each node of the pair of nodes.

5. The computer implemented method of claim 1, further comprising:
in response to filtering the incoming network packets on the new VLAN device with the new VLAN device identifier, untagging the incoming network packets on the new VLAN device.

6. The computer implemented method of claim 1, further comprising:
filtering incoming network packets on the original VLAN device with the original VLAN device identifier.

7. The computer implemented method of claim 1, further comprising:
in response to tagging outgoing network packets on the new VLAN device with the new VLAN device identifier, removing the original VLAN device from the VLAN.

8. A computer program product residing on a non-transitory computer readable medium having a plurality of instructions stored thereon which, when executed by a processor, cause the processor to perform operations comprising:
processing network packets to and from a multi-node storage system within a Virtual Local Area Network (VLAN) using an original VLAN device with a VLAN device identifier;
generating a new VLAN device with a new VLAN device identifier within the VLAN;
filtering incoming network packets on the new VLAN device with the new VLAN device identifier;
tagging outgoing network packets on the new VLAN device with an original VLAN device identifier;
modifying the original VLAN device on each node of the multi-node storage system to tag outgoing network packets on the original VLAN device with the new VLAN device identifier; and
in response to modifying the original VLAN device to tag outgoing network packets on the original VLAN with the new VLAN device identifier on each node of the multi-node storage system, tagging outgoing network packets on the new VLAN device with the new VLAN device identifier.

9. The computer program product of claim 8, wherein the VLAN device couples the multi-node storage system with one or more external host devices.

10. The computer program product of claim 8, wherein the multi-node storage system includes a pair of nodes in an active-active storage configuration.

11. The computer program product of claim 10, wherein generating the new VLAN device includes generating the new VLAN device on each node of the pair of nodes.

12. The computer program product of claim 8, wherein the operations further comprise:
in response to filtering the incoming network packets on the new VLAN device with the new VLAN device identifier, untagging the incoming network packets on the new VLAN device.

13. The computer program product of claim 8, wherein the operations further comprise:
filtering incoming network packets on the original VLAN device with the original VLAN device identifier.

14. The computer program product of claim 8, wherein the operations further comprise:
in response to tagging outgoing network packets on the new VLAN device with the new VLAN device identifier, removing the original VLAN device from the VLAN.

15. A computing system comprising:
a memory; and
a processor configured to process network packets to and from a multi-node storage system within a Virtual Local Area Network (VLAN) using an original VLAN device with a VLAN device identifier, to generate a new VLAN device with a new VLAN device identifier within the VLAN, to filter incoming network packets on the new VLAN device with the new VLAN device identifier, to tag outgoing network packets on the new VLAN device with an original VLAN device identifier, to modify the original VLAN device on each node of the multi-node storage system to tag outgoing network packets on the original VLAN device with the new VLAN device identifier, and, in response to modifying the original VLAN device to tag outgoing network packets on the original VLAN with the new VLAN device identifier on each node of the multi-node storage system, to tag outgoing network packets on the new VLAN device with the new VLAN device identifier.

16. The computing system of claim 15, wherein the VLAN device couples the multi-node storage system with one or more external host devices.

17. The computing system of claim 15, wherein the multi-node storage system includes a pair of nodes in an active-active storage configuration.

18. The computing system of claim 17, wherein generating the new VLAN device includes generating the new VLAN device on each node of the pair of nodes.

19. The computing system of claim 15, wherein the processor is further configured to:
in response to filtering the incoming network packets on the new VLAN device with the new VLAN device identifier, untag the incoming network packets on the new VLAN device.

20. The computing system of claim 15, wherein the processor is further configured to:
filter incoming network packets on the original VLAN device with the original VLAN device identifier.
